(19) United States
(12) Patent Application Publication
(10) Pub. No.: US 2026/0333441 A1
(43) Pub. Date: Oct. 22, 2026

(54) METHOD AND DEVICE FOR RANDOM ACCESS CHANNEL TRANSMISSION IN NON-TERRESTRIAL NETWORK

(71) Applicants: HYUNDAI MOTOR COMPANY, Seoul (KR); Kia Corporation, Seoul (KR); INHA UNIVERSITY RESEARCH AND BUSINESS FOUNDATION, Incheon (KR)

(72) Inventors: Young Kil Suh, Hwaseong-si, Gyeonggi-do (KR); Ui Hyun Hong, Hwaseong-si, Gyeonggi-do (KR); Jeong Su Lee, Hwaseong-si, Gyeonggi-do (KR); Duk Kyung Kim, Seoul (KR)

(73) Assignees: HYUNDAI MOTOR COMPANY, Seoul (KR); Kia Corporation, Seoul (KR); INHA UNIVERSITY RESEARCH AND BUSINESS FOUNDATION, Incheon (KR)

(21) Appl. No.: 19/109,494

(22) PCT Filed: Oct. 31, 2023
(86) PCT No.: PCT/KR2023/017154

§ 371 Date: Mar. 6, 2025

(30) Foreign Application Priority Data
Oct. 31, 2022 (KR) 10-2022-0142972

(51) Int. Cl. H04W 74/0833; H04B 7/10

(52) U.S. Cl. CPC H04W 74/0833; H04B 7/10

(57) ABSTRACT

A technology of transmitting a random access channel in a non-terrestrial network may be provided. A method by a user equipment (UE) may be provided, the method comprising the steps of: receiving, from a satellite, random access channel (RACH) configuration information including information on the number of repetitions for each transmission order and information on a RACH resource; selecting a RACH resource of the transmission order of N from the RACH configuration information; and repeating a random preamble of the selected RACH resource by an identified number of repetitions and transmitting same to the satellite, wherein N is a positive integer.

### TECHNICAL FIELD

The present disclosure relates to a technique for transmitting a random access channel in a non-terrestrial network, and more particularly, to a technique for repeated transmission of a random access channel using polarizations in a non-terrestrial network.

### BACKGROUND ART

A communication network (e.g. 5G communication network, 6G communication network, etc.) to provide enhanced communication services compared to the existing communication network (e.g. long term evolution (LTE), LTE-Advanced (LTA-A), etc.) is being developed. The 5G communication network (e.g. new radio (NR) communication network) can support not only a frequency band of 6 GHz or below, but also a frequency band of 6 GHz or above. That is, the 5G communication network can support a frequency range (FR1) band and/or FR2 band. The 5G communication network can support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and the like.

The 6G communication network can support a variety of communication services and scenarios compared to the 5G communication network. The 6G communication networks can meet the requirements of hyper-performance, hyper-bandwidth, hyper-space, hyper-precision, hyper-intelligence, and/or hyper-reliability. The 6G communication networks can support various and wide frequency bands and can be applied to various usage scenarios (e.g. terrestrial communication, non-terrestrial communication, sidelink communication, and the like).

The communication network (e.g. 5G communication network, 6G communication network, etc.) may provide communication services to terminals located on the ground. Recently, the demand for communication services for not only terrestrial but also non-terrestrial airplanes, drones, and satellites has been increasing, and for this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g. airplane, drone, or the like) may be performed based on 5G communication technology, 6G communication technology, and/or the like. In the NTN, the satellite may perform functions of a base station in a communication network (e.g. 5G communication network, 6G communication network, and/or the like).

Meanwhile, in a non-terrestrial network, link quality may be poor due to a long distance between a satellite and a terminal, as well as significant Doppler shifts caused by high-speed movement. To overcome this, it may be required to improve reception performance through repeated transmissions of a random access channel (RACH) in an initial access process in uplink.

### DISCLOSURE

### Technical Problem

The present disclosure is directed to providing a method and an apparatus for repeated transmission of a random access channel using polarizations in a non-terrestrial network.

### Technical Solution

A method of a user equipment (UE) for transmitting a random access channel in a non-terrestrial network, according to a first exemplary embodiment of the present disclosure for achieving the above-described objective, may comprise: receiving, from a satellite, random access channel (RACH) configuration information including information on a transmission-stage-specific number of repetitions and information on transmission-stage-specific RACH resources; determining whether a transmission stage of a random access (RA) preamble transmission is an N-th stage; in response to the transmission stage being the N-th stage, determining a number of repetitions for the N-th stage transmission, based on the RACH configuration information; selecting RACH resources for the N-th transmission stage based on the RACH configuration information; and repeatedly transmitting an RA preamble of the selected RACH resources to the satellite by the determined number of repetitions, wherein N is a positive integer.

The number of repetitions for the N-th stage transmission may be 2N-1 or 2×(N−1).

The information on the transmission-stage-specific RACH resources may include information on transmission-stage-specific preamble sequence(s) and information on transmission-stage-specific RACH occasion(s), and the selecting of the RACH resources for the N-th stage transmission based on the RACH configuration information may comprise: selecting a preamble sequence for the N-th stage transmission order based on the RACH configuration information; and selecting RACH occasion(s) for the N-th stage transmission based on the RACH configuration information.

The UE may select the preamble sequence from preamble sequence(s) for the N-th stage transmission, and generate the RA preamble based on the selected preamble sequence.

The RACH configuration information may include information on a transmission-stage-specific polarization pattern, and the repeatedly transmitting of the RA preamble of the selected RACH resources to the satellite may comprise: selecting a preamble sequence from preamble sequences of the selected RACH resources; generating the RA preamble based on the selected preamble sequence; determining a polarization pattern for the N-th stage transmission; and repeatedly transmitting the RA preamble to the satellite by the determined number of repetitions based on the determined polarization pattern.

When the determined number of repetitions is R, the transmission-stage-specific polarization patten is composed of a transmission-stage-specific identification polarization pattern related to a repetition number of M of the RA preamble and a transmission-stage-specific remaining polarization pattern related to a repetition number of (R-M) of the RA preamble, and the repeatedly transmitting of the RA preamble of the selected RACH resources to the satellite may comprise: transmitting the RA preamble to the satellite by repeating the RA preamble with the repetition number of M corresponding to the transmission-stage-specific identification polarization pattern of the determined polarization pattern; and transmitting the RA preamble to the satellite by repeating the RA preamble with the repetition number of (R-M) corresponding to the transmission-stage-specific remaining polarization pattern of the determined polarization pattern, wherein R and M are positive integers, and M is smaller than R.

The transmission-stage-specific identification polarization pattern may be configured as a combination of right-hand circular polarization and left-hand circular polarization or a combination of horizontal polarization and vertical polarization.

A method of a satellite for receiving a random access channel in a non-terrestrial network, according to a second exemplary embodiment of the present disclosure for achieving the above-described objective, may comprise: transmitting, to a user equipment (UE), random access channel (RACH) configuration information including information on transmission-stage-specific identification polarization patterns; receiving RA preambles transmitted from the UE according to the RACH configuration information, based on the RACH configuration information; determining a transmission-stage-specific identification polarization pattern by identifying a polarization pattern of the received RA preambles; and restoring the RA preamble by combining a number of the RA preambles corresponding to a transmission-stage-specific number of repetitions according to the determined transmission-stage-specific identification polarization pattern.

The restoring of the RA preamble by combining a number of the RA preambles corresponding to the transmission-stage-specific number of repetitions according to the determined transmission-stage-specific identification polarization pattern may comprise: identifying the transmission-stage-specific number of repetitions according to the determined transmission-stage-specific identification polarization pattern; and restoring the RA preamble by combining a number of RA preambles corresponding to the identified transmission-stage-specific number of repetitions.

The RACH configuration information may include information on transmission-stage-specific RACH occasions, and the receiving of the RA preambles transmitted from the UE according to the RACH configuration information may comprise: receiving the RA preambles by performing monitoring on the transmission-stage-specific RACH occasions according to the RACH configuration information.

The transmission-stage-specific identification polarization pattern may be configured as a combination of right-hand circular polarization and left-hand circular polarization or a combination of horizontal polarization and vertical polarization.

A user equipment (UE) for transmitting a random access channel in a non-terrestrial network, according to a third exemplary embodiment of the present disclosure for achieving the above-described objective, may comprise at least one processor, and the at least one processor causes the UE to perform: receiving, from a satellite, random access channel (RACH) configuration information including information on a transmission-stage-specific number of repetitions and information on transmission-stage-specific RACH resources; determining whether a transmission stage of a random access (RA) preamble transmission is an N-th stage; in response to the transmission stage being the N-th stage, determining a number of repetitions for the N-th stage transmission, based on the RACH configuration information; selecting RACH resources for the N-th transmission stage based on the RACH configuration information; and repeatedly transmitting an RA preamble of the selected RACH resources to the satellite by the determined number of repetitions, wherein N is a positive integer.

The information on the transmission-stage-specific RACH resources may include information on transmission-stage-specific preamble sequence(s) and information on transmission-stage-specific RACH occasion(s), and in the selecting of the RACH resources for the N-th stage transmission based on the RACH configuration information, the at least one processor may further cause the UE to perform: selecting a preamble sequence for the N-th stage transmission order based on the RACH configuration information; and selecting RACH occasion(s) for the N-th stage transmission based on the RACH configuration information.

The RACH configuration information may include information on a transmission-stage-specific polarization pattern, and in the repeatedly transmitting of the RA preamble of the selected RACH resources to the satellite, the at least one processor may further cause the UE to perform: selecting a preamble sequence from preamble sequences of the selected RACH resources; generating the RA preamble based on the selected preamble sequence; determining a polarization pattern for the N-th stage transmission; and repeatedly transmitting the RA preamble to the satellite by the determined number of repetitions based on the determined polarization pattern.

### Advantageous Effects

According to the present disclosure, a terminal can increase the number of repetitions of a preamble as the transmission stage increases. Furthermore, according to the present disclosure, the terminal can implicitly inform a satellite base station of information on the number of repetitions corresponding to the transmission stage by using a polarization pattern. Accordingly, according to the present disclosure, the satellite base station can determine the number of repetitions using the polarization pattern, and receive the preamble from the terminal by combining the repeatedly-transmitted preambles.

### DESCRIPTION OF DRAWINGS

FIG. 1A is a conceptual diagram illustrating a first exemplary embodiment of a non-terrestrial network.

FIG. 1B is a conceptual diagram illustrating a second exemplary embodiment of a non-terrestrial network.

FIG. 2A is a conceptual diagram illustrating a third exemplary embodiment of a non-terrestrial network.

FIG. 2B is a conceptual diagram illustrating a fourth exemplary embodiment of a non-terrestrial network.

FIG. 2C is a conceptual diagram illustrating a fifth exemplary embodiment of a non-terrestrial network.

FIG. 3 is a block diagram illustrating a first exemplary embodiment of a communication node constituting a non-terrestrial network.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6A is a conceptual diagram illustrating a first exemplary embodiment of a protocol stack of a user plane in a transparent payload-based non-terrestrial network.

FIG. 6B is a conceptual diagram illustrating a first exemplary embodiment of a protocol stack of a control plane in a transparent payload-based non-terrestrial network.

FIG. 7A is a conceptual diagram illustrating a first exemplary embodiment of a protocol stack of a user plane in a regenerative payload-based non-terrestrial network.

FIG. 7B is a conceptual diagram illustrating a first exemplary embodiment of a protocol stack of a control plane in a regenerative payload-based non-terrestrial network.

FIG. 8 is a conceptual diagram illustrating a first exemplary embodiment of an association relationship between RACH occasions (ROs) and SSBs in the time-frequency domain.

FIG. 9 is a flowchart illustrating a first exemplary embodiment of a random access channel transmission method in a non-terrestrial network.

FIG. 10 is a flowchart illustrating a second exemplary embodiment of a random access channel transmission method in a non-terrestrial network.

### BEST MODE OF THE INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In the present disclosure, “(re) transmission” may refer to “transmission”, “retransmission”, or “transmission and retransmission”, “(re)configuration” may refer to “configuration”, “reconfiguration”, or “configuration and reconfiguration”, “(re) connection” may refer to “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted. In addition to the exemplary embodiments explicitly described in the present disclosure, operations may be performed according to a combination of the exemplary embodiments, extensions of the exemplary embodiments, and/or modifications of the exemplary embodiments. Performance of some operations may be omitted, and the order of performance of operations may be changed.

Even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g. payload-based NTN), operations of a base station may refer to operations of a satellite, and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In the present disclosure, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g. master information block (MIB), system information block (SIB)) and/or RRC messages. The MAC signaling may refer to a transmission and reception operation of a MAC control element (CE). The PHY signaling may refer to a transmission and reception operation of control information (e.g. downlink control information (DCI), uplink control information (UCI), and sidelink control information (SCI)).

In the present disclosure, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In the present disclosure, “signal and/or channel” may mean a signal, a channel, or “signal and channel,” and “signal” may be used to mean “signal and/or channel”.

A communication system may include at least one of a terrestrial network, non-terrestrial network, 4G communication network (e.g. long-term evolution (LTE) communication network), 5G communication network (e.g. new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which exemplary embodiments are applied is not limited to the content described below, and the exemplary embodiments may be applied to various communication networks (e.g. 4G communication network, 5G communication network, and/or 6G communication network). Here, a communication network may be used in the same sense as a communication system.

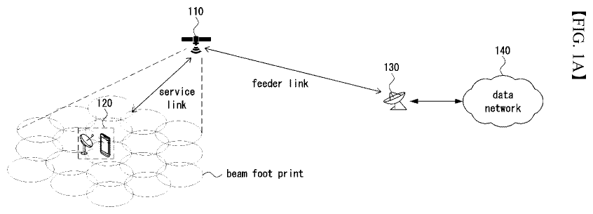

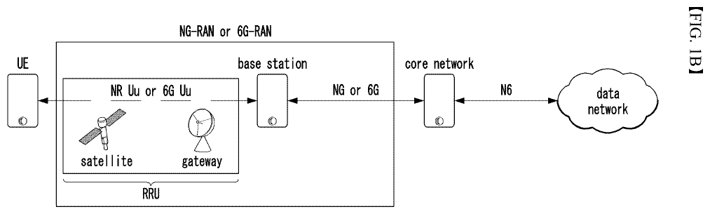

FIG. 1A is a conceptual diagram illustrating a first exemplary embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS). A non-GEO satellite may be an LEO satellite and/or MEO satellite.

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may be referred to as an NTN payload. The gateway 130 may support a plurality of NTN payloads. The satellite 110 may provide communication services to the communication node 120 using one or more beams. The shape of a footprint of the beam of the satellite 110 may be elliptical or circular.

In the non-terrestrial network, three types of service links can be supported as follows.
Earth-fixed: a service link may be provided by beam(s) that continuously cover the same geographic area at all times (e.g. geosynchronous orbit (GSO) satellite).
quasi-earth-fixed: a service link may be provided by beam(s) covering one geographical area during a limited period and provided by beam(s) covering another geographical area during another period (e.g. non-GSO (NGSO) satellite forming steerable beams).
earth-moving: a service link may be provided by beam(s) moving over the Earth's surface (e.g. NGSO satellite forming fixed beams or non-steerable beams).

The communication node 120 may perform communications (e.g. downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g. base stations supporting 4G, 5G, and/or 6G functionality) as well as the satellite 110, and perform DC operations based on the techniques defined in 4G, 5G, and/or 6G technical specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface, a 6G-Uu interface, or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the 4G communication technology, 5G communication technology, and/or 6G communication technology. For example, the core network may include an access and mobility management function (AMF), a user plane function (UPF), a session management function (SMF), and the like. The communications between the gateway 130 and the core network may be performed based on an NG-C/U interface or 6G-C/U interface.

As shown in an exemplary embodiment of FIG. 1B, there may be a ‘core network’ between the gateway 130 and the data network 140 in a transparent payload-based NTN.

FIG. 1B is a conceptual diagram illustrating a second exemplary embodiment of a non-terrestrial network.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface, and the communications between the base station and the core network (e.g. AMF, UPF, SMF, and the like) may be performed based on an NG-C/U interface or 6G-C/U interface.

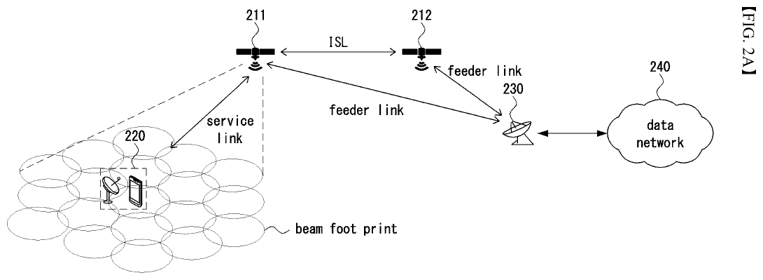

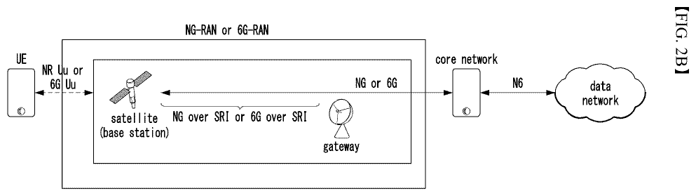

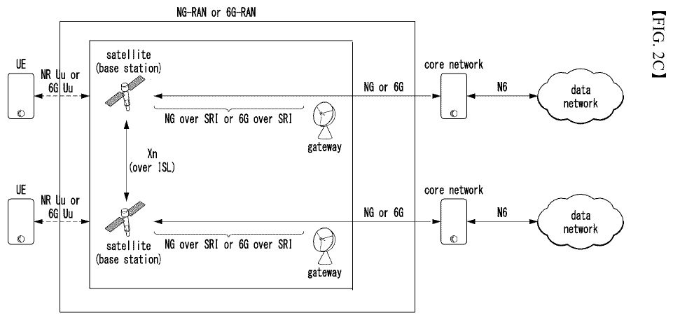

FIG. 2A is a conceptual diagram illustrating a third exemplary embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g. base stations supporting 4G, 5G, and/or 6G functionality) as well as the satellite 211, and may perform DC operations based on the techniques defined in 4G, 5G, and/or 6G technical specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

As shown in exemplary embodiments of FIG. 2B and FIG. 2C, there may be a ‘core network’ between the gateway 230 and the data network 240.

FIG. 2B is a conceptual diagram illustrating a fourth exemplary embodiment of a non-terrestrial network, and FIG. 2C is a conceptual diagram illustrating a fifth exemplary embodiment of a non-terrestrial network.

As shown in FIG. 2B and FIG. 2C, the gateway may be connected with the core network, and the core network may be connected with the data network. The core network may support the 4G communication technology, 5G communication technology, and/or 6G communication technology. For example. The core network may include AMF, UPF, SMF, and the like. Communication between the gateway and the core network may be performed based on an NG-C/U interface or 6G-C/U interface. Functions of a base station may be performed by the satellite. That is, the base station may be located on the satellite. The base station located on the satellite may be a base station-distributed unit (DU), and a base station-centralized unit (CU) may be located within an NG-RAN or a 6G-RAN. A payload may be processed by the base station located on the satellite. Base stations located on different satellites may be connected to the same core network. One satellite may have one or more base stations. In the non-terrestrial network of FIG. 2B, an ISL between satellites may not be established, and in the non-terrestrial network of FIG. 2C, an ISL between satellites may be established.

Meanwhile, the entities (e.g. satellite, base station, UE, communication node, gateway, and the like) constituting the non-terrestrial network shown in FIGS. 1A, 1B, 2A, 2B, and/or 2C may be configured as follows. In the present disclosure, the entity may be referred to as a communication node.

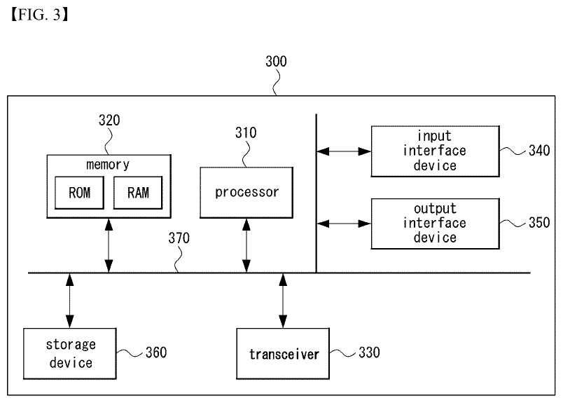

FIG. 3 is a block diagram illustrating a first exemplary embodiment of a communication node constituting a non-terrestrial network.

As shown in FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

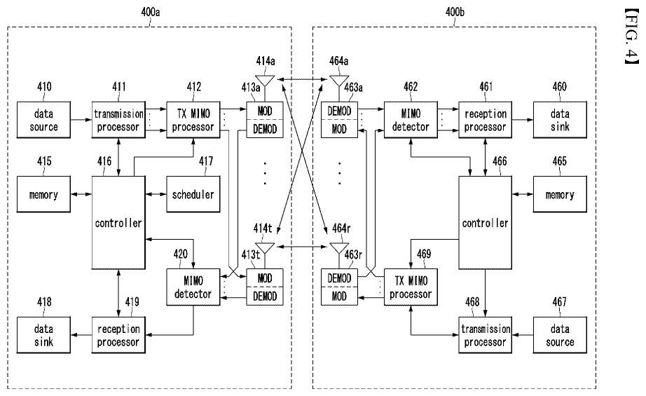

Meanwhile, communication nodes that perform communications in the communication network (e.g. non-terrestrial network) may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

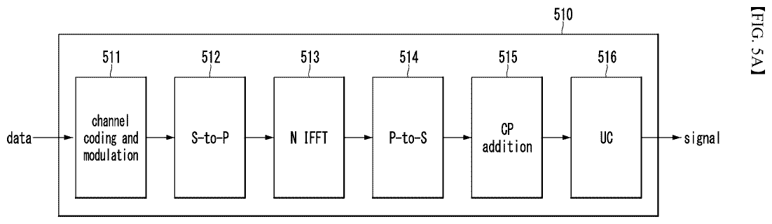

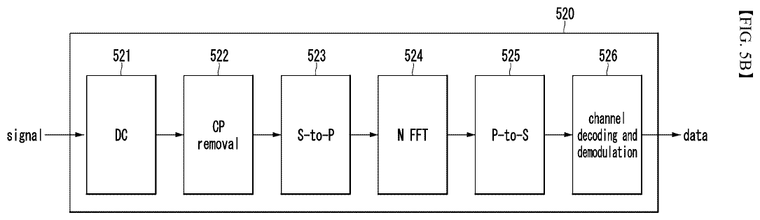

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, NTN reference scenarios may be defined as shown in Table 1 below.

TABLE 1

| | NTN shown in FIG. 1 | NTN shown in FIG. 2 |
|---|---|---|
| GEO | Scenario A | Scenario B |
| LEO (steerable | Scenario C1 | Scenario D1 |
| beams) | | |
| LEO (beams | Scenario C2 | Scenario D2 |
| moving with | | |
| satellite) | | |

When the satellite 110 in the NTN shown in FIG. 1A and/or FIG. 1B is a GEO satellite (e.g. a GEO satellite that supports a transparent function), this may be referred to as ‘scenario A’. When the satellites 211 and 212 in the NTN shown in FIG. 2A, FIG. 2B, and/or FIG. 2C are GEO satellites (e.g. GEOs that support a regenerative function), this may be referred to as ‘scenario B’. When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’.

Parameters for the NTN reference scenarios defined in Table 1 may be defined as shown in Table 2 below.

TABLE 2

| | Scenarios A and B | | Scenarios C and D |
|---|---|---|---|
| Altitude | 35,786 | km | 600 km |
| | | | 1,200 km |
| Spectrum | <6 GHz (e.g. 2 GHz) | | |
| (service link) | >6 GHz (e.g. DL 20 GHz, UL 30 GHz) | | |
| Maximum channel | 30 MHz for band <6 GHz | | |
| bandwidth capability | 1 GHz for band >6 GHz | | |
| (service link) | | | |
| Maximum distance | 40,581 | km | 1,932 km (altitude of |
| between satellite and | | | 600 km) |
| communication node | | | 3,131 km (altitude of |
| (e.g. UE) at the | | | 1,200 km) |
| minimum elevation | | | |
| angle | | | |
| Maximum round trip | Scenario A: 541.46 ms | | Scenario C: |
| delay (RTD) (only | (service and feeder links) | | (transparent payload: |
| propagation delay) | Scenario B: 270.73 | | service and feeder |
| | ms (only service link) | | links) |
| | | | −5.77 ms (altitude of |
| | | | 60 0 km) |
| | | | −41.77 ms (altitude of |
| | | | 1,200 km) |
| | | | Scenario D: |
| | | | (regenerative payload: |
| | | | only service link) |
| | | | −12.89 ms (altitude of |
| | | | 600 km) |
| | | | −20.89 ms (altitude of |
| | | | 1,200 km) |
| Maximum differential | 10.3 | ms | 3.12 ms (altitude of |
| delay within a cell | | | 600 km) |
| | | | 3.18 ms (altitude of |
| | | | 1,200 km) |

| | |
|---|---|
| Service link | NR defined in 3GPP |
| Feeder link | Radio interfaces defined in |
| | 3GPP or non-3GPP |

In addition, in the scenarios defined in Table 1, delay constraints may be defined as shown in Table 3 below.

TABLE 3

| | | | Scenario | Scenario |
|---|---|---|---|---|
| | Scenario A | Scenario B | C1-2 | D1-2 |
| Satellite altitude | 35,786 km | | 600 km | |
| Maximum RTD in a | 541.75 ms | 270.57 ms | 28.41 ms | 12.88 ms |
| radio interface | (worst case) | | | |
| between base | | | | |
| station and UE | | | | |
| Minimum RTD in a | 477.14 ms | 238.57 ms | 8 ms | 4 ms |
| radio interface | | | | |
| between base | | | | |
| station and UE | | | | |

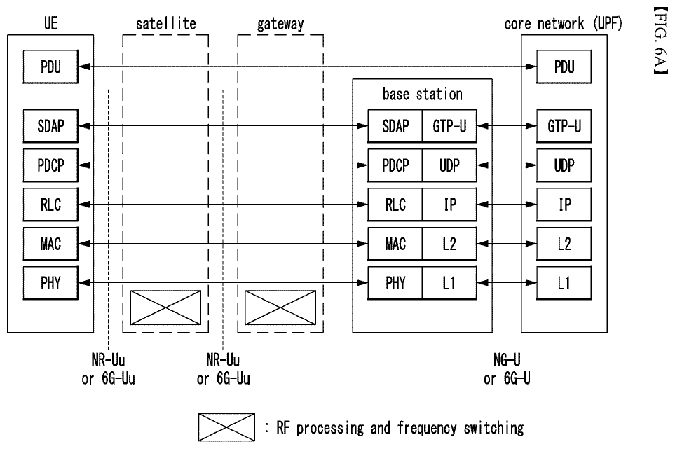

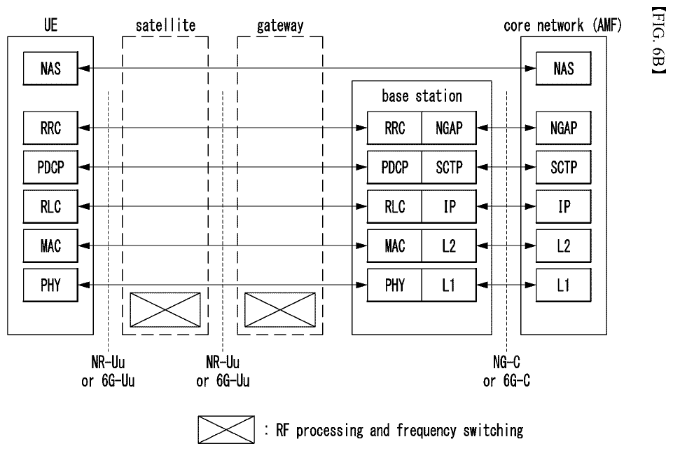

FIG. 6A is a conceptual diagram illustrating a first exemplary embodiment of a protocol stack of a user plane in a transparent payload-based non-terrestrial network, and FIG. 6B is a conceptual diagram illustrating a first exemplary embodiment of a protocol stack of a control plane in a transparent payload-based non-terrestrial network. As shown in FIGS. 6A and 6B, user data may be transmitted and received between a UE and a core network (e.g. UPF), and control data (e.g. control information) may be transmitted and received between the UE and the core network (e.g. AMF). Each of the user data the and control data may be transmitted and received through a satellite and/or gateway. The protocol stack of the user plane shown in FIG. 6A may be applied identically or similarly to a 6G communication network. The protocol stack of the control plane shown in FIG. 6B may be applied identically or similarly to a 6G communication network.

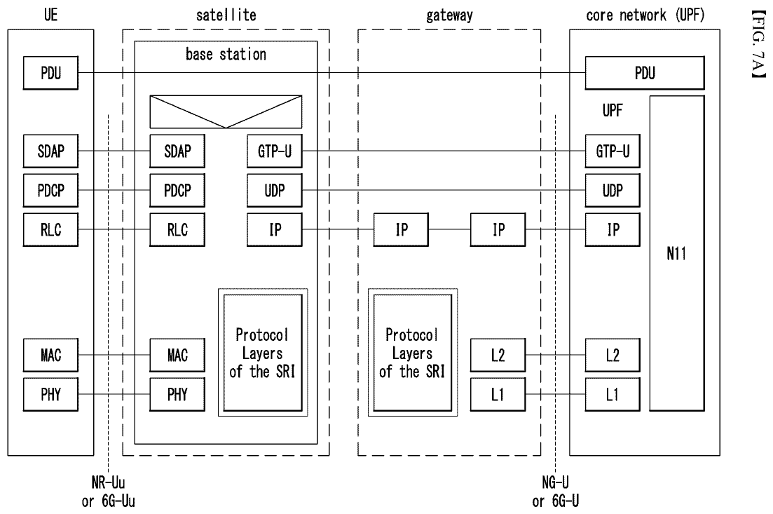

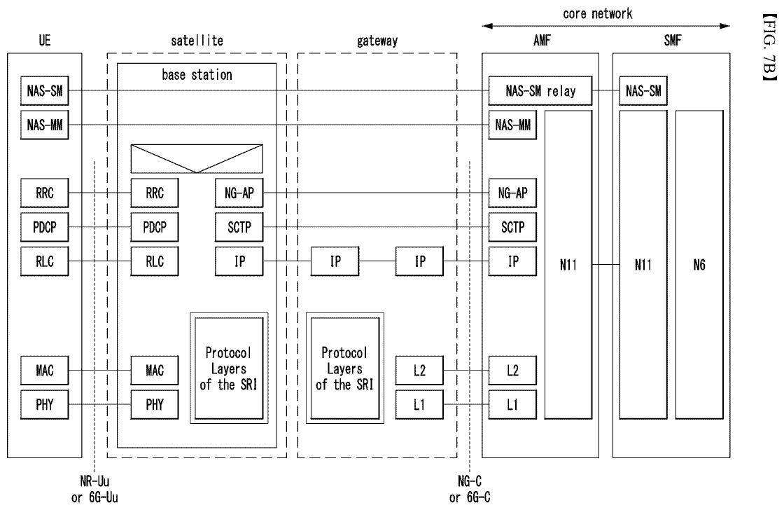

FIG. 7A is a conceptual diagram illustrating a first exemplary embodiment of a protocol stack of a user plane in a regenerative payload-based non-terrestrial network, and FIG. 7B is a conceptual diagram illustrating a first exemplary embodiment of a protocol stack of a control plane in a regenerative payload-based non-terrestrial network.

As shown in FIGS. 7A and 7B, each of user data and control data (e.g. control information) may be transmitted and received through an interface between a UE and a satellite (e.g. base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

Meanwhile, in a non-terrestrial network, a base station may transmit system information (e.g. SIB19) including satellite assistance information for NTN access. A UE may receive the system information (e.g. SIB19) from the base station, identify the satellite assistance information included in the system information, and perform communication (e.g. non-terrestrial communication) based on the satellite assistance information. The SIB19 may include information element(s) defined in Table 4 below.

TABLE 4
SIB19-r17 ::= SEQUENCE {

| | |
|---|---|
| ntn-Config-r17 | NTN-Config-r17 |
| t-Service-r17 | INTEGER(0..549755813887) |
| referenceLocation-r17 | ReferenceLocation-r17 |
| distanceThresh-r17 | INTEGER(0..65525) |
| ntn-NeighCellConfigList-r17 | NTN-NeighCellConfigList-r17 |
| lateNonCriticalExtension | OCTET STRING |

```
  ...,
  [[
```

| | |
|---|---|
| ntn-NeighCellConfigListExt-v1720 | NTN-NeighCellConfigList-r17 |

]]
}

| | |
|---|---|
| NTN-NeighCellConfigList-r17 ::= | SEQUENCE (SIZE(1..maxCellNTN-r17)) |

OF NTN-NeighCellConfig-r17

| | |
|---|---|
| NTN-NeighCellConfig-r17 ::= | SEQUENCE { |
| ntn-Config-r17 | NTN-Config-r17 |
| carrierFreq-r17 | ARFCN-ValueNR |
| physCellId-r17 | PhysCellId |

}

NTN-Config defined in Table 4 may include information element(s) defined in Table 5 below.

TABLE 5

| | |
|---|---|
| NTN-Config-r17 ::= | SEQUENCE { |
| epochTime-r17 | EpochTime-r17 |

ntn-UlSyncValidityDuration-r17 ENUMERATED{ s5, s10, s15, s20, s25, s30, s35,
s40, s45, s50, s55, s60, s120, s180, s240, s900}

| | |
|---|---|
| cellSpecificKoffset-r17 | INTEGER(1..1023) |
| kmac-r17 | INTEGER(1..512) |
| ta-Info-r17 | TA-Info-r17 |
| ntn-PolarizationDL-r17 | ENUMERATED {rhcp,lhcp,linear} |
| ntn-PolarizationUL-r17 | ENUMERATED {rhcp,lhcp,linear} |
| ephemerisInfo-r17 | EphemerisInfo-r17 |
| ta-Report-r17 | ENUMERATED {enabled} |

...
}

| | |
|---|---|
| EpochTime-r17 ::= | SEQUENCE { |
| sfn-r17 | INTEGER(0..1023), |
| subFrameNR-r17 | INTEGER(0..9) |

}

| | |
|---|---|
| TA-Info-r17 ::= | SEQUENCE { |
| ta-Common-r17 | INTEGER(0..66485757), |
| ta-CommonDrift-r17 | INTEGER(−257303..257303) |
| ta-CommonDriftVariant-r17 | INTEGER(0..28949) |

}

EphemerisInfo defined in Table 5 may include information element(s) defined in Table 6 below.

TABLE 6

| | |
|---|---|
| EphemerisInfo-r17 ::= | CHOICE { |
| positionVelocity-r17 | PositionVelocity-r17, |
| orbital-r17 | Orbital-r17 |
| } | |
| PositionVelocity-r17 ::= | SEQUENCE { |
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |

}

| | |
|---|---|
| Orbital-r17 ::= | SEQUENCE { |
| semiMajorAxis-r17 | INTEGER (0..8589934591), |
| eccentricity-r17 | INTEGER (0..1048575), |
| periapsis-r17 | INTEGER (0..268435455), |
| longitude-r17 | INTEGER (0..268435455), |
| inclination-r17 | INTEGER (−67108864..67108863), |
| meanAnomaly-r17 | INTEGER (0..268435455) |

}
PositionStateVector-r17 ::= INTEGER (−33554432..33554431)
VelocityStateVector-r17 ::= INTEGER (−131072..131071)

Meanwhile, in a non-terrestrial network, link quality may be poor due to a long distance between a satellite and a terminal and large Doppler shifts caused by high-speed movement. To overcome this, studies on coverage enhancement (CE) have been actively discussed since Release 17. In particular, improving random access channel (RACH) performance in uplink may be a key issue under discussion.

In an existing terrestrial network, a power ramping scheme may be one scheme for RACH preamble transmission. The power ramping scheme may improve RACH reception performance by gradually increasing a terminal power while transmitting the RACH preamble.

However, in a non-terrestrial network, a transmission distance between a satellite and a terminal may be long. Therefore, even when using the maximum power, the satellite may have difficulty successfully receiving a RACH preamble transmitted from the terminal. When the terminal gradually increases transmission power and transmits the RACH preamble using the maximum transmission power but the satellite fails to receive the RACH preamble, a method for compensating therefor may be needed.

Accordingly, in a non-terrestrial network, the terminal may repeatedly transmit a preamble to improve reception performance of the preamble at the satellite. In this case, the satellite can receive the preamble by combining preamble transmissions performed by the terminal based on the number of repetitions.

In this case, the number of repetitions may be fixed. Accordingly, the satellite may be able to combine and receive the preamble based on the number of repetitions known in advance. However, when the number of repetitions is fixed, both the terminal and the satellite need to always use the fixed number of repetitions, which may be inefficient. Therefore, to utilize physical random access channel (PRACH) resources more efficiently, the terminal may gradually increase the number of repetitions of the transmitted preamble as the transmission stage increases. Furthermore, in the non-terrestrial network environment, various transmission schemes utilizing polarization may be used. Accordingly, if the terminal transmits a non-terrestrial network preamble using polarization, reception performance can be improved.

Meanwhile, the 94th 3rd Generation Partnership Project (3GPP) radio access network (RAN) technical plenary in December 2021 has discussed coverage enhancements as follows.
The objective of Release 18 focuses on applying solutions developed to enhance general NR coverage to NTN.
The following items are discussed as examples of areas to be considered in the next stage of studies. Additionally, the RAN technical plenary discusses evaluation of coverage issues specific to NTNs that have been identified as actual study items.
NTN-specific repetition enhancement beyond techniques covered in the Release 17 coverage enhancement work item for related channels
NTN-specific techniques for improving diversity and/or reducing polarization loss

Meanwhile, at the 109-e meeting of work group 1 (WG1) of the RAN technical plenary in April 2022, LG Electronics primarily has discussed the following as potential enhancement points for initial access procedures.
In the Release 17 coverage enhancement (CE) study item stage, coverage enhancement for uplink signals/channels in the initial access procedure may be required. Therefore, repetition of a PRACH preamble and repetition of a Msg3 physical uplink shared channel (PUSCH) may be considered. However, due to insufficient discussion time, the Release 17 CE work item stage has introduced repeated Msg3 PUSCH transmission, which has a higher priority, while repeated PRACH preamble transmission, which has a lower priority, has been additionally introduced in the Release 17 CE work item stage. The Release 18 CE work item stage proposes coverage enhancement for NR NTNs.
It may be desirable to consider introducing both repeated PRACH preamble transmission and repeated Msg3 PUSCH transmission in Release 18 NTN.
However, since NR does not support repeated PRACH preamble transmission, the following discussion points may need to be considered to support repeated PRACH preamble transmission.
First, it may be required to determine the maximum number of repetitions.
Second, since a terminal may be defined to repeatedly transmit a PRACH preamble through multiple RACH occasions (ROs), a reference RO may be defined so that the terminal and the network use the same random access radio network temporary identifier (RA-RNTI).
Lastly, additional UE operations may need to be defined to determine a start point of a random access response (RAR) window.
Meanwhile, at the 109-e meeting of WG1 of the RAN technical plenary in April 2022, Nokia has discussed the following regarding improvement of Msg3 PUSCH.
Msg3 PUSCH has been identified as a coverage bottleneck in the NR system. For this reason, Msg3 repetition has been introduced in Release 17 to improve reliability of Msg3 detection and decoding.
The main agreements regarding activation of Msg3 repetition may be as follows.
A UE may request repetition of Msg3 when a measured synchronization signal reference signal received quality (SS-RSRP) is below an RSRP threshold configured through system information block (SIB)1.
A base station may indicate the number of Msg3 repetitions using two repurposed bits of a modulation and coding scheme (MCS) field in an uplink grant of Msg2 in the RAR.

Meanwhile, at the 109-e meeting of WG1 of the RAN technical plenary in April 2022, Sony has discussed the following for improving NTN NR coverage.
Polarization indication for NTN communication has been discussed in Release 17, where explicit indication of downlink polarization by a network is supported based on SIB. Meanwhile, information on a polarization for uplink may be indicated by the network in SIB. When information on the polarization for uplink is not provided, UEs may assume the same polarization for both uplink and downlink. In terms of polarization mode, right-hand circular polarization (RHCP), left-hand circular polarization (LHCP), or linear polarization may be indicated in the SIB for both downlink and/or uplink polarization information.
Provision of explicit information on UE capabilities may be needed for Release 18 NTN to mitigate polarization loss and may be a direct improvement.
For frequency range 1 (FR 1) handsets, polarization may generally vary depending on UE's orientation, making polarization reconfiguration difficult. Advanced very small aperture terminal (VSAT) antennas may generally be able to automatically change polarization, and commercial handset terminals in frequency range 2 (FR 2) may also be able to do so.

Meanwhile, for initial access, a terminal may receive system information from a base station, including the following.
The number of RACH occasions available per synchronization signal block (SSB)
The number of contention-based preambles available
A preamble format to be used
Frequency domain resources
Time domain resources (slots and symbols)
Initial power for PRACH transmission

The base station may provide terminals with RACH-related information through SIBI or radio resource control (RRC) configuration based on the following RACH configuration common parameters. Table 7 below may be an example of NR RACH configuration.

TABLE 7

rach-ConfigCommon setup:
rach-ConfigGeneric
prach-ConfigurationIndex 75,
msg1-FDM one,
msg1-Frequency Start 0,
zeroCorrelationZoneConfig 0,
preambleReceivedTargetPower −109,
preambleTransMax n10,
powerRampingStep dB4,
ra-Response Window sl20,
totalNumberOfRA-Preambles 8,
ssb-perRACH-OccasionAndCB-PreamblesPerSSB one: n8,
ra-ContentionResolutionTimer sf16,
prach-RootSequenceIndex 1139: 91,
msg1-SubcarrierSpacing kHz 120,
restrictedSetConfig unrestrictedSet

Here, the prach-ConfigurationIndex field may refer to a table for RACH configuration indexes. This table may define a PRACH format to be used, a timing of PRACH transmission in the time domain, and the number of available RACH occasions. Next, the msg1-FDM field may represent the number of PRACH transmissions that are frequency-division multiplexed (FDM) at a time. Here, the number of PRACH transmissions may be up to eight RACH occasions at once. The msg1-FrequencyStart field may indicate an offset of the lowest PRACH transmission occasion in the frequency domain relative to a physical resource block (PRB) 0. Next, the preambleTransMax field may represent the maximum number of RA preamble transmissions performed before declaring a failure. The totalNumberOfRA-Preambles field may indicate the total number of preambles available per PRACH occasion for both contention-based and contention-free RACH. Next, the ssb-perRACH-OccasionAndCB-PreamblesPerSSB field may have two meanings. Here, ssb-perRACH-Occasion may provide information on the number of SSBs mapped per RACH occasion. Meanwhile, CB-PreamblesPerSSB may indicate the number of contention-based preambles available per SSB.

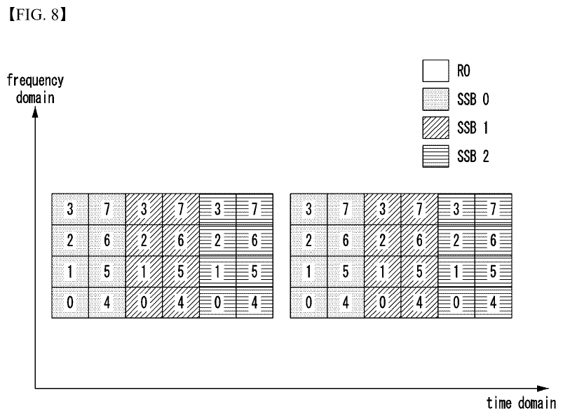

FIG. 8 is a conceptual diagram illustrating a first exemplary embodiment of an association relationship between RACH occasions (ROs) and SSBs in the time-frequency domain.

As shown in FIG. 8, when a PRACH configuration index is 133, 6 different ROs may be defined. If the number of SSBs is ⅛, one SSB may be allocated to 8 consecutive ROs. Here, the msg1-FDM field may be 4.

Meanwhile, in the TN, a preamble transmission power P_{PRACH,target} for RACH Msg1 may be determined by Equation 1 below.

P_{PRACH,target}=preambleReceivedTargetPower+Delta_Preamble+(PREAMBLE_POWER_RAMPING_COUNTER−1)×PREAMBLE_POWER_RAMPING_STEP [Equation 1]

Here, preambleReceivedTargetPower may be configured for the UE by the base station through RRC signaling. Delta_Preamble may depend on the PRACH preamble format. The UE may convert prach-ConfigurationIndex into a preamble format and then refers to Table 8 to obtain Delta_Preamble.

TABLE 8

| Preamble format | Delta_Preamble | |
|---|---|---|
| 0 | 0 | dB |
| 1 | −3 | dB |
| 2 | −6 | dB |
| 3 | 0 | dB |

Next, Preamble_Transmission_Counter may represent the number of PRACH attempts. It may be 1 for initial transmission and may increase by 1 for each retransmission. powerRampingStep may be configured for the UE and may be 0/2/4/6 dB. Meanwhile, in the present disclosure, when the UE transmits a PRACH preamble, the UE may transmit the preamble with an increased number of repetitions in the current transmission stage than in the previous transmission stage. In addition, in the present disclosure, the UE may implicitly indicate the current transmission stage by using a polarization pattern applied to the first N preambles. Here, the transmission stage may represent a transmission sequence, where the first transmission is called the first-stage transmission, the next transmission as the second-stage transmission, the subsequent transmission as the third-stage transmission, and so on, continuing to increase to fourth-order and beyond. The number of repetitions may refer to the number of times the same preamble is repeatedly transmitted in each transmission stage. Each transmission stage and the number of repetitions may be mapped in a one-to-one manner. In this case, the preamble may be repeatedly transmitted in the time domain. The base station may receive the preamble repeatedly transmitted from the UE and combine received signals to reconstruct the preamble transmitted by the UE. As a result, the signal-to-noise ratio (SNR) may increase, thereby improving preamble reception performance.

Meanwhile, considering a long delay in NTN, it may be difficult for a satellite base station to determine whether the preamble has been received in the previous transmission stage. Therefore, the satellite base station may have difficulty combining preambles transmitted across different transmission stages for reception. Consequently, the reception performance improvement through combining receptions may be feasible only for preambles repeatedly transmitted within the same transmission stage. In this case, the UE may increase the number of repetitions within the same transmission stage as the transmission stage increases. A mapping relationship between the transmission stage and the number of repetitions may be as shown in Table 9.

TABLE 9

| | Number (R) of | Number (R) of |
|---|---|---|
| Transmission | repetitions | repetitions |
| stage | (Case 1) | (Case 2) |
| 1 | 1 | 1 |
| 2 | 2 | 2 |
| 3 | 4 | 4 |
| 4 | 8 | 6 |
| . | . | . |
| . | . | . |
| . | . | . |
| N | R = 2^{N-1} | R = 2 × (N − 1) |

In Case 1 of Table 9, the UE may transmit the preamble with the number 2^{N-1} of repetitions according to the transmission stage N. In Case 2 of Table 9, the UE may increase the number of repetitions by a factor of 2 as the transmission stage N increases. In this case, the UE may transmit the preamble at the maximum transmission power. From a power control perspective, a power ramping counter may reach its maximum value. In the present disclosure, if the UE transmits the preamble at maximum power, the satellite base station may still fail to successfully receive the preamble. In such cases, the UE may repeatedly transmit the preamble to enhance the preamble reception performance at the satellite base station. In this case, the UE may perform preamble transmission by combining repeated transmission and power control. This method may be easily extended as a simple combination of the method disclosed in the present disclosure and the conventional power control scheme. In this case, by configuring the initial transmission as the n-th transmission, the UE may transmit the preamble to the satellite base station with the number of repetitions greater than 1. Subsequent schemes may be described based on the configuration of Table 9. Here, n may be a positive integer.

Meanwhile, the satellite base station may separately allocate RACH resources by distinguishing between a case of using a transmission polarization pattern in the first-stage transmission or a case of using a transmission polarization pattern in the second-stage transmission. Here, the RACH resource may be a preamble sequence or an RO. In this manner, the satellite base station may distinguish resources using the preamble sequences and ROs. In addition, the satellite base station may notify the UE of information on the distinguished resources through SIBI or an RRC reconfiguration. In this case, when there are multiple UEs, each UE may support different types of polarization. Accordingly, the UE may inform the satellite base station of the types of polarization it can support. Then, the satellite base station may receive information on the supported polarization types from the UE. Based on the received information on the supported polarization types, the satellite base station may allocate RACH resources to each UE.

For example, the satellite base station may allocate some of the preamble sequences and ROs to a RACH resource group A, while allocating the remaining resources to a RACH resource group B. Here, the size of each of the RACH resource groups A and B may be determined by the satellite base station. For example, in the case of a long sequence preamble, the satellite base station may allocate PRACHRootSequenceIndex values from 0 to n1 to the RACH resource group A and allocate the remaining PRACHRootSequenceIndex values to the RACH resource group B. The UE may transmit a preamble using either the RACH resource group A or RACH resource group B.

In other words, the UE may select a preamble sequence from the preamble sequences allocated to the RACH resource group A. Then, the UE may generate a preamble based on the selected preamble sequence. Subsequently, the UE may transmit the generated preamble. Similarly, the UE may select a preamble sequence from the preamble sequences allocated to the RACH resource group B. Then, the UE may generate a preamble based on the selected preamble sequence and transmit the generated preamble.

However, the satellite base station may not know in advance whether the UE has transmitted the preamble using the RACH resource group A or RACH resource group B. Accordingly, the satellite base station may consider both the RACH resource group A and RACH resource group B as available. As a result, the satellite base station may monitor RACH resources belonging to both groups. In other words, the satellite base station may not be able to distinguish whether the UE performed the first-stage transmission or the second-stage transmission based on the polarization of the first preamble transmission. Here, the resource group A may be RACH resources that use the polarization pattern of the preambles in the first-stage transmission. Meanwhile, the resource group B may be RACH resources that use the polarization pattern of the preambles transmitted in the second-stage transmission. Here, n1 may be a positive integer.

Meanwhile, the UE may repeatedly transmit the preamble to the satellite base station using a polarization pattern across two or more transmission stages. In this case, the UE may repeatedly transmit the preamble to the satellite base station with the polarization pattern mapped to each transmission stage in two or more transmission stages. The UE may apply a different polarization pattern for each transmission stage. In particular, the UE may configure a beginning part of the polarization pattern differently for each transmission stage. Here, the beginning part may be, for example, a pattern consisting of polarizations used to transmit two preambles first within the polarization pattern, as shown in Table 10. The beginning part may be referred to as an ‘identification polarization pattern for each transmission stage’.

TABLE 10

| | | Repeated transmission | The subsequent |
|---|---|---|---|
| | | pattern of first two | polarization |
| | | preambles (i.e. | pattern (i.e. |
| Transmission | Number of | identification | the remaining |
| stage | repetitions | polarization pattern) | polarization pattern) |
| 2 | 2 | LL | |
| 3 | 4 | LR | XX |
| 4 | 6 | RL | XXXX |
| 5 | 8 | RR | XXXXXX |

Then, the satellite base station may repeatedly receive the preamble from the UE. In addition, the satellite base station may identify the polarization pattern of the preambles received from the UE. Accordingly, the satellite base station may distinguish the identification polarization pattern from the received polarization pattern. Then, the satellite base station may determine the transmission stage based on the distinguished identification polarization pattern using Table 10 and infer the number of repetitions. For example, considering Case 2 of Table 9, the satellite base station may use Table 10 to determine the number of repetitions up to 8 preamble transmissions. In this case, in Table 10, the combination of L and R used for the transmission of two preambles may be an identification polarization pattern. Here, L may represent left-hand circular polarization (LHCP), and R may represent right-hand circular polarization (RHCP). Additionally, the polarization of the preamble transmission represented as ‘X’ in Table 10 may have an arbitrary polarization. Such repeated preamble transmission may be expected to enhance the received SNR due to diversity gained from multiple preamble transmissions and polarization diversity. Here, the fundamental assumption is that the preambles repeatedly transmitted within the same transmission stage may be combined at the satellite base station for reception. Meanwhile, the satellite base station may utilize preambles combined across transmission stages. However, in an NTN environment, a time interval between transmission stages is expected to be significantly large. Consequently, in an NTN environment, channel variations such as Doppler shift values may be substantial. Moreover, the satellite base station may fail to properly receive the preamble from the previous transmission stage. As a result, the satellite base station may not be able to easily implement preamble combining across transmission stages.

Meanwhile, the identification polarization pattern that may be used for the first two preamble transmissions may be generalized. For example, when using linear polarization, the satellite base station may implement an identification polarization pattern by utilizing vertical (V) polarization and horizontal (H) polarization. Additionally, when using circular polarization, the satellite base station may implement an identification polarization pattern by utilizing not only L or R separately but also both L and R simultaneously. In such cases, the number of identification polarization patterns may be increased to 9, calculated as 3×3. Accordingly, in Case 2 of Table 9, the terminal may implicitly inform the satellite base station of the number of repetitions for up to 18 repeated transmissions.

Meanwhile, the polarization patterns (i.e. the remaining polarization patterns) excluding the identification polarization patterns may be represented with ‘X’ in Table 10. Such remaining polarization patterns may be predefined between the terminal and the satellite base station. Accordingly, the satellite base station may be aware of the remaining polarization patterns. If the satellite base station does not know the remaining polarization patterns, blind detection may be performed for all possible polarization combinations, thereby increasing complexity.

As an example, in the third-stage transmission, four remaining polarization patterns, namely RR, RL, LR, and LL, may be assumed. If the satellite base station does not know the remaining polarization patterns used by the terminal in the third-stage transmission, reception may be attempted for all remaining polarization patterns. In this case, in the case of the fourth-stage transmission, the terminal may use 16 remaining polarization patterns, and reception may be attempted for all remaining polarization patterns. As a result, complexity may rapidly increase.

Meanwhile, the satellite base station may not accurately determine the polarization pattern used by the terminal based solely on the first two preamble receptions. To address such a case, the satellite base station may use the polarization pattern used in the first four preamble transmissions as the identification polarization pattern to improve preamble reception performance. In such a case, the satellite base station may allocate additional RACH resources to implicitly determine the number of repetitions used in the first-stage transmission. In other words, a different RACH resource group may be allocated depending on the number of preamble transmissions used to identify the polarization pattern. In such a case, the satellite base station may allocate an additional resource group C in addition to the previously allocated RACH resource groups A and B. Here, the resource group C may be RACH resources that utilizes the polarization patterns of the first three preamble transmissions. If only the resource groups A and B are allocated, the satellite base station may not be able to determine the polarization pattern of the first two preamble transmissions. In such a case, the initial access of the terminal may fail.

Meanwhile, the satellite base station may allocate a different RACH resource group depending on whether the first-stage transmission is performed or not and the number of repetitions, thereby enabling the terminal to transmit the preamble accordingly. Since the RACH preamble is transmitted before establishing a connection between the satellite base station and the terminal, the satellite base station may not be aware of whether the terminal performs repeated transmissions. Accordingly, the satellite base station may distinguish a case where the first-stage transmission is performed with one repetition and other cases based on the RACH resource used by the terminal. If the terminal uses the resource group B, the satellite base station may determine the polarization pattern used by the terminal based on the identification pattern used in the first two preamble transmissions.

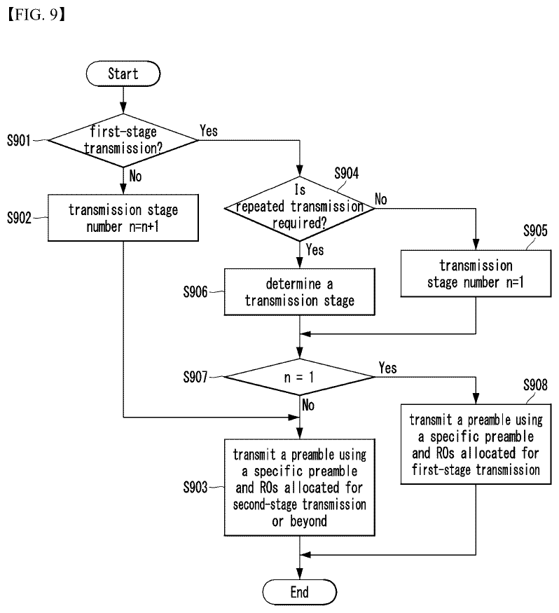

FIG. 9 is a flowchart illustrating a first exemplary embodiment of a random access channel transmission method in a non-terrestrial network.

As shown in FIG. 9, a terminal may determine whether current transmission is a first-stage transmission (S901). If the determination result indicates that the current transmission is not a first-stage transmission, the terminal may increase a transmission stage number of the current transmission by 1 (S902). Then, the terminal may transmit a preamble using the resource group B (S903). On the other hand, if the determination result indicates that the current transmission is a first-stage transmission, the terminal may additionally determine whether repeated transmission is required (S904). If the determination result indicates that repeated transmission is not required, the terminal may set the transmission stage number of the current transmission to 1 (S905). In this case, if repeated transmission is required, the terminal may determine a transmission stage corresponding to the required repetitions (S906). Then, the terminal may determine whether the transmission stage number of the current transmission is 1 (S907). If the determination result indicates that the transmission stage number of the current transmission is 1, the terminal may transmit a preamble using a specific preamble or RO allocated for the first-stage transmission (S908). Then, the satellite base station and the satellite may proceed with the subsequent random access procedure. On the other hand, if the transmission stage number of the current transmission is not 1, the terminal may transmit a preamble using a specific preamble or ROs allocated for the second-stage transmission or beyond (S903). The satellite base station may receive the preamble from the terminal through the specific preamble or ROs allocated for the second-stage transmission. Then, the satellite base station and the satellite may proceed with the subsequent random access procedure.

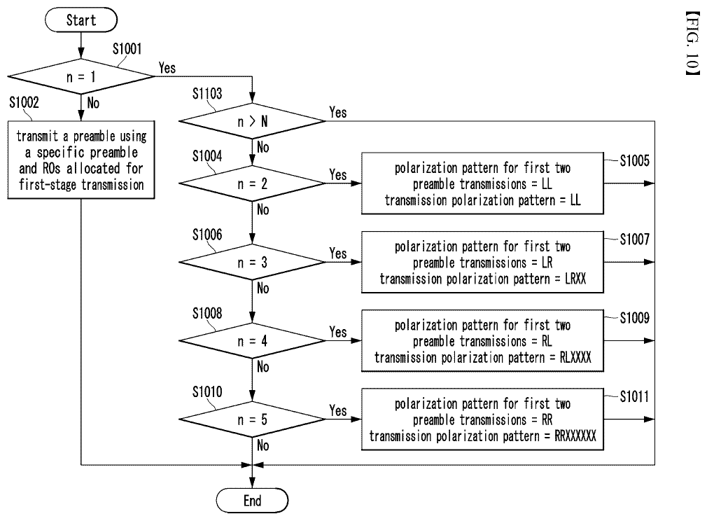

FIG. 10 is a flowchart illustrating a second exemplary embodiment of a random access channel transmission method in a non-terrestrial network.

As shown in FIG. 10, a terminal may determine whether current transmission is a first-stage transmission (S1001). If the determination result indicates that the current transmission is a first-stage transmission, the terminal may transmit a preamble to the satellite base station using a specific preamble or RO allocated for the first-stage transmission (S1002). The satellite base station may receive the preamble from the terminal through the specific preamble or RO allocated for the first-stage transmission. Then, the satellite base station and the satellite may proceed with the subsequent random access procedure. On the other hand, if the current transmission is not a first-stage transmission, the terminal may determine whether the current transmission is a transmission with a stage number greater than the maximum transmission stage N (S1003). Here, n and N may be positive integers.

If the determination result indicates that the current transmission is a transmission with a stage number greater than the maximum transmission stage, the process may terminate. If the current transmission is not a transmission with a stage number greater than the maximum transmission stage, the terminal may transmit a preamble using a resource or ROs allocated for the second-stage transmission. In this case, if the current transmission is the second-stage transmission (S1004), the terminal may sequentially use the polarizations corresponding to the identification polarization pattern LL used for the first two preamble transmissions, to repeatedly transmit the preamble to the satellite base station (S1005). The satellite base station may receive the preamble from the terminal by combining signals received through the specific preamble or ROs allocated for the second-stage transmission or beyond. Then, the satellite base station and the satellite may proceed with the subsequent random access procedure.

On the other hand, if the current transmission is a third-stage transmission (S1006), the terminal may sequentially use the polarizations corresponding to the identification polarization pattern LR, which is used for the first two preamble transmissions, to repeatedly transmit the preamble to the satellite base station. Then, the terminal may sequentially use the polarizations corresponding to the remaining polarization pattern XX, which is used for the remaining repeated transmissions, to repeatedly transmit the preamble to the base station (S1007). The satellite base station may receive the preamble from the terminal by combining signals received through the specific preamble or ROs allocated for the second-stage transmission or beyond. Then, the satellite base station and the satellite may proceed with the subsequent random access procedure.

On the other hand, if the current transmission is a fourth-stage transmission (S1008), the terminal may sequentially use the polarizations corresponding to the identification polarization pattern RL, which is used for the first two preamble transmissions, to repeatedly transmit the preamble to the satellite base station. Then, the terminal may sequentially use the polarizations corresponding to the remaining polarization pattern XXX, which is used for the remaining repeated transmissions, to repeatedly transmit the preamble to the base station (S1009). The satellite base station may receive the preamble from the terminal by combining signals received through the specific preamble or ROs allocated for the second-stage transmission or beyond. Then, the satellite base station and the satellite may proceed with the subsequent random access procedure.

On the other hand, if the current transmission is a fifth-stage transmission (S1010), the terminal may sequentially use the polarizations corresponding to the identification polarization pattern RR, which is used for the first two preamble transmissions, to repeatedly transmit the preamble to the satellite base station. Then, the terminal may sequentially use the polarizations corresponding to the remaining polarization pattern XXXX, which is used for the remaining repeated transmissions, to repeatedly transmit the preamble to the base station (S1011). The satellite base station may receive the preamble from the terminal by combining signals received through the specific preamble or ROs allocated for the second-stage transmission or beyond. Then, the satellite base station and the satellite may proceed with the subsequent random access procedure.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner. The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a user equipment (UE), comprising:
receiving, from a satellite, random access channel (RACH) configuration information including information on a transmission-stage-specific number of repetitions and information on transmission-stage-specific RACH resources;
determining whether a transmission stage of a random access (RA) preamble transmission is an N-th stage;
in response to the transmission stage being the N-th stage, determining a number of repetitions for the N-th stage transmission, based on the RACH configuration information;
selecting RACH resources for the N-th transmission stage based on the RACH configuration information; and
repeatedly transmitting an RA preamble of the selected RACH resources to the satellite by the determined number of repetitions,
wherein N is a positive integer.

2. The method according to claim 1, wherein the number of repetitions for the N-th stage transmission is 2^{N-1} or 2×(N−1).

3. The method according to claim 1, wherein the information on the transmission-stage-specific RACH resources include information on transmission-stage-specific preamble sequence(s) and information on transmission-stage-specific RACH occasion(s), and the selecting of the RACH resources for the N-th stage transmission based on the RACH configuration information comprises:
selecting a preamble sequence for the N-th stage transmission order based on the RACH configuration information; and
selecting RACH occasion(s) for the N-th stage transmission based on the RACH configuration information.

4. The method according to claim 3, wherein the UE selects the preamble sequence from preamble sequence(s) for the N-th stage transmission, and generates the RA preamble based on the selected preamble sequence.

5. The method according to claim 1, wherein the RACH configuration information includes information on a transmission-stage-specific polarization pattern, and the repeatedly transmitting of the RA preamble of the selected RACH resources to the satellite comprises:
selecting a preamble sequence from preamble sequences of the selected RACH resources;
generating the RA preamble based on the selected preamble sequence;
determining a polarization pattern for the N-th stage transmission; and
repeatedly transmitting the RA preamble to the satellite by the determined number of repetitions based on the determined polarization pattern.

6. The method according to claim 5, wherein when the determined number of repetitions is R, the transmission-stage-specific polarization patten is composed of a transmission-stage-specific identification polarization pattern related to a repetition number of M of the RA preamble and a transmission-stage-specific remaining polarization pattern related to a repetition number of (R-M) of the RA preamble, and the repeatedly transmitting of the RA preamble of the selected RACH resources to the satellite comprises:
transmitting the RA preamble to the satellite by repeating the RA preamble with the repetition number of M corresponding to the transmission-stage-specific identification polarization pattern of the determined polarization pattern; and
transmitting the RA preamble to the satellite by repeating the RA preamble with the repetition number of (R-M) corresponding to the transmission-stage-specific remaining polarization pattern of the determined polarization pattern,
wherein R and M are positive integers, and M is smaller than R.

7. The method according to claim 6, wherein the transmission-stage-specific identification polarization pattern is configured as a combination of right-hand circular polarization and left-hand circular polarization or a combination of horizontal polarization and vertical polarization.

8. A method of a satellite, comprising:
transmitting, to a user equipment (UE), random access channel (RACH) configuration information including information on transmission-stage-specific identification polarization patterns;
receiving RA preambles transmitted from the UE according to the RACH configuration information, based on the RACH configuration information;
determining a transmission-stage-specific identification polarization pattern by identifying a polarization pattern of the received RA preambles; and
restoring the RA preamble by combining a number of the RA preambles corresponding to a transmission-stage-specific number of repetitions according to the determined transmission-stage-specific identification polarization pattern.

9. The method according to claim 8, wherein the restoring of the RA preamble by combining a number of the RA preambles corresponding to the transmission-stage-specific number of repetitions according to the determined transmission-stage-specific identification polarization pattern comprises:
identifying the transmission-stage-specific number of repetitions according to the determined transmission-stage-specific identification polarization pattern; and
restoring the RA preamble by combining a number of RA preambles corresponding to the identified transmission-stage-specific number of repetitions.

10. The method according to claim 8, wherein the RACH configuration information includes information on transmission-stage-specific RACH occasions, and the receiving of the RA preambles transmitted from the UE according to the RACH configuration information comprises: receiving the RA preambles by performing monitoring on the transmission-stage-specific RACH occasions according to the RACH configuration information.

11. The method according to claim 8, wherein the transmission-stage-specific identification polarization pattern is configured as a combination of right-hand circular polarization and left-hand circular polarization or a combination of horizontal polarization and vertical polarization.

12. A user equipment (UE) comprising at least one processor, wherein the at least one processor causes the UE to perform:
receiving, from a satellite, random access channel (RACH) configuration information including information on a transmission-stage-specific number of repetitions and information on transmission-stage-specific RACH resources;
determining whether a transmission stage of a random access (RA) preamble transmission is an N-th stage;
in response to the transmission stage being the N-th stage, determining a number of repetitions for the N-th stage transmission, based on the RACH configuration information;
selecting RACH resources for the N-th transmission stage based on the RACH configuration information; and
repeatedly transmitting an RA preamble of the selected RACH resources to the satellite by the determined number of repetitions,
wherein N is a positive integer.

13. The UE according to claim 12, wherein the information on the transmission-stage-specific RACH resources include information on transmission-stage-specific preamble sequence(s) and information on transmission-stage-specific RACH occasion(s), and in the selecting of the RACH resources for the N-th stage transmission based on the RACH configuration information, the at least one processor further causes the UE to perform:
selecting a preamble sequence for the N-th stage transmission order based on the RACH configuration information; and
selecting RACH occasion(s) for the N-th stage transmission based on the RACH configuration information.

14. The UE according to claim 12, wherein the RACH configuration information includes information on a transmission-stage-specific polarization pattern, and in the repeatedly transmitting of the RA preamble of the selected RACH resources to the satellite, the at least one processor further causes the UE to perform:
selecting a preamble sequence from preamble sequences of the selected RACH resources;
generating the RA preamble based on the selected preamble sequence;
determining a polarization pattern for the N-th stage transmission; and
repeatedly transmitting the RA preamble to the satellite by the determined number of repetitions based on the determined polarization pattern.
